(19) United States
(12) Patent Application Publication
(10) Pub. No.: US 2025/0252336 A1
(43) Pub. Date: Aug. 7, 2025

(54) QUANTUM MACHINE LEARNING USING GENETIC ALGORITHMS

(71) Applicant: STANDARD CHARTERED BANK, SINGAPORE BRANCH, Singapore (SG)

(72) Inventors: Steve Yongxin CAO, Singapore (SG); Elena STRBAC, London (GB)

(73) Assignee: STANDARD CHARTERED BANK, SINGAPORE BRANCH, Singapore (SG)

(21) Appl. No.: 19/046,628

(22) Filed: Feb. 6, 2025

(30) Foreign Application Priority Data
Feb. 7, 2024 (SG) 10202400348P

(51) Int. Cl. G06N 10/60

(52) U.S. Cl. CPC G06N 10/60

(57) ABSTRACT

Methods and systems for determining a target QNN configuration for a problem domain by generating a population of candidate QNN configurations based on a plurality of features, performing a genetic search in the population of QNN configurations for a target QNN by iteratively evolving the population of QNN configurations based on fitness metrics to identify a target QNN configuration with the highest fitness metric.

### CROSS REFERENCE TO RELATED APPLICATIONS

The present application claims priority from Singapore patent application Ser. No. 10202400348P filed on Feb. 7, 2024, and entitled “QUANTUM MACHINE LEARNING USING GENETIC ALGORITHMS”, the disclosure of which is incorporated herein by reference.

### TECHNICAL FIELD

This disclosure generally relates to systems and methods relating to use of quantum computers for machine learning.

### BACKGROUND

Conventional machine learning models such as neural networks have provided a significant advance in the computational capability of classical computers in solving classification or regression problems. By mimicking biological structures and processes in classical computers, neural networks provide greater accuracy and efficiency.

Quantum computers leverage quantum mechanical properties of matter to perform computations. In quantum computing, information is represented using qubits that exist in a superposition of basis states. By leveraging the unique properties of quantum information represented using qubits, quantum computers exponentially reduce the time complexity of some computation problems such as NP-hard problems.

Machine learning techniques and constructs such as neural networks are designed for classical computers and are not readily incorporated in quantum computers. Because of the unique representation of quantum information and the distinctiveness of quantum operations, the conventional approached for optimizing neural networks in classical computers such as backpropagation to perform gradient descent cannot be readily implemented in quantum computers. As an example, several conventional machine learning models incorporate differentiable objective functions to perform regression or classification tasks. The objective functions are optimized for a particular context using techniques such as gradient descent. The differentiable character of the objective function allows the application of optimization techniques such as gradient descent to convention machine learning models. While this conventional approach to machine learning works well for classical computers, the same approach when applied to quantum computers is not technically feasible because of the non-differentiable and probabilistic nature of quantum information.

### SUMMARY

Some embodiments relate to a method for determining a target Quantum Neural Network (QNN) configuration for binary classification, the method comprising:
receiving a binary classification dataset, the dataset comprising a plurality of feature data and target classification data;
generating a population of candidate QNN configurations based on the plurality of features, each candidate QNN configuration defining a QNN comprising a random mapping of each of the plurality of features to at least one qubit of the QNN and entanglement relationships between the qubits;
performing a genetic search in the population of QNN configurations for a target QNN configuration by:
   simulated execution of candidate QNNs initialized using the each QNN configuration in the population of QNN configurations;
   computing a fitness metric for each of the candidate QNNs based on outputs of simulated execution of the candidate QNNs and the target classification data; and
   iteratively evolving the population of QNN configurations based on the fitness metrics to identify a target QNN configuration with the highest fitness metric.

In some embodiments, iterative evolution of the population of QNN configurations comprises:
selection of a subset of the QNN configurations based on the computed fitness metrics;
generation of a subsequent population of QNN configurations by random mutation operations on the subset of the QNN configurations.

In some embodiments, each QNN configuration comprises at least one configuration value defining operations performed on qubits in each layer of the QNN.

In some embodiments, the entanglement relationships between the qubits of the QNNs defined by the QNN configurations comprise multi-layered hierarchical entanglement relationships.

In some embodiments, the multi-layered hierarchical entanglement relationships comprise two qubit groups at each layer, wherein number of qubits in the two qubit groups at each layer are determined based on a tree split ratio.

The method of some embodiments further comprises:
generating at least one guiding feature based on one or more of the plurality of features; and
each candidate QNN configuration comprising a mapping of each guiding feature to at least one qubit as defined in the QNN configuration.

The method of some embodiments further comprises random sampling of records in the domain dataset; and simulated execution of candidate QNNs using the randomly sampled records.

The method of some embodiments further comprises defining a QNN based on the identified target QNN configuration; and deploying the QNN based on the identified target QNN configuration to process live data and generate binary classification inferences.

In some embodiments, the number of qubits in each candidate QNN configuration is less than the total number of features in the dataset; and at least a subset of qubits in each QNN configuration encode more than one feature data.

In some embodiments, mutation comprises introducing a random rotation to a subset of qubits of the QNNs defined by the subset of the QNN configurations.

Some embodiments relate to a method for determining a target Quantum Neural Network (QNN) configuration for a problem domain, the method comprising:
receiving a problem domain dataset, the dataset comprising a plurality of feature data and target variable data;
generating a population of candidate QNN configurations based on the plurality of features, each candidate QNN configuration defining a QNN comprising a random mapping of each of the plurality of features to at least one qubit of the QNN and entanglement relationships between the qubits;
performing a genetic search in the population of QNN configurations for a target QNN configuration by:
   simulated execution of candidate QNNs initialized using the each QNN configuration in the population of QNN configurations;
   computing a fitness metric for each of the candidate QNNs based on outputs of simulated execution of the candidate QNNs and the target variable data; and
   iteratively evolving the population of QNN configurations based on the fitness metrics to identify a target QNN configuration with the highest fitness metric.

The method of some embodiments further comprises defining a QNN based on the identified target QNN configuration; and deploying the QNN based on the identified target QNN configuration to process live data and generate inferences.

Some embodiments relate to a quantum computing system, the system comprising: a quantum circuit generated according to a target QNN configuration, wherein the target QNN configuration is determined by execution of the disclosed method of determining a target Quantum Neural Network (QNN).

### BRIEF DESCRIPTION OF THE FIGURES

Embodiments described herein are illustrated by way of example and not limitation in the figures of the accompanying drawings in which like references indicate similar elements, and in which:

FIG. 1 illustrates a block diagram of a system for determining QNN configurations and execution of the determined QNN configurations;

FIG. 2 illustrates a method of determining QNN configuration executable by at least a part of the system of FIG. 1;

FIG. 3 illustrates a method of evolution of QNN configurations executed as part of the method of FIG. 2;

FIG. 4 illustrates a quantum circuit generated by implementing a QNN configuration;

FIGS. 5A and 5B illustrate another quantum circuit generated by implementing a QNN configuration;

FIG. 6 illustrates a schematic diagram for defining entanglement in quantum circuits; and

FIG. 7 illustrates another schematic diagram for defining entanglement in quantum circuits.

### DETAILED DESCRIPTION

This disclosure relates to methods and systems for determining a configuration for Quantum Neural Networks (QNNs) that provides improved results for machine learning tasks such as classification or regression. The disclosure incorporates genetic algorithms to determine the QNN configurations best suited for a specific problem domain. Advantageously, the disclosure provides an approach for determining QNN configuration that provide more accurate results. Further, the disclosure also provides an approach for identification of a more suitable QNN configuration for a problem domain in a more autonomous manner.

A traditional machine learning (ML) model such as a neural network relies on differentiable objective functions. During training of a traditional ML model, a gradient descent approach is used to update the model parameters iteratively. However, in the realm of quantum computing, formulating a differentiable objective is challenging due to two reasons. Firstly, the output of a quantum computer comprises discrete probability masses, which are not readily differentiable. Secondly, the current quantum computing hardware is in the “Noisy Intermediate Scale Quantum” (NISQ) era, meaning that the hardware itself is still in development. The calculated objective function for a quantum computer comprises noise-induced barren plateaus (NIBPs). A gradient descent approach is not readily applicable to the optimization of quantum circuits because of the NIBPs.

One approach of leveraging the NISQ computers is to use Variational Quantum Algorithms (VQAs) and limiting the scale of the problems addressed by the quantum computer. As the NISQ computers are used to address problems of a larger scale (larger number of parameters/features etc.) and the conventional gradient optimization techniques encounter the problem of exponentially vanishing gradients leading to suboptimal or unacceptable outcomes. Barren plateaus in the gradient function imply that to optimize an objective function to produce high accuracy results, a very high number of training iterations may be required while not necessarily improving the likelihood of the discovery of the global minima.

The genetic/evolutionary algorithm based approach of this disclosure provides a computationally feasible and efficient mechanism for determining the configuration of a quantum neural network while circumventing the technical problems associated with the NIBPs in the conventional approach to gradient optimization.

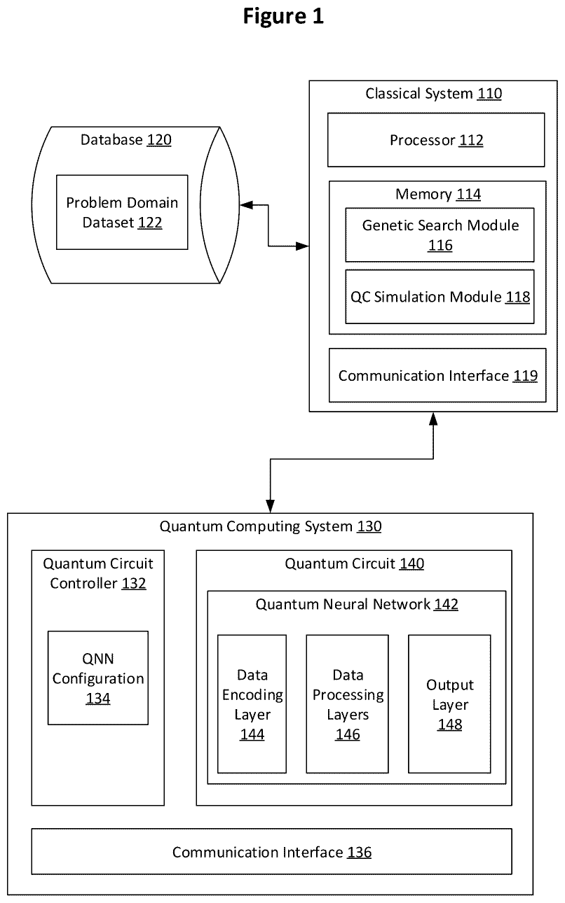

FIG. 1 illustrates a block diagram of a system for determining QNN configurations and execution of the determined QNN configurations. The QNN configurations are determined by a classical system 110 operating on problem domain dataset 122 accessible through database 120. The problem domain dataset 122 comprises conventional training data organized into features/parameters and one or more target variable data. In some embodiments, the problem domain dataset 122 comprises a binary classification dataset wherein the target variable (target classification data) is a binary variable. Each row in the problem dataset comprises a set of feature data and a target variable data. The target variable data is the attribute of interest and is intended to be predicted by a QNN for live data. The feature data may be observable data or observations available from measurements in the real world that serve as inputs for prediction of the target variable. In embodiments where the problem domain relates to a binary classification problem, the target variable is a binary variable. In embodiments, where the problem domain relates to a multi-class classification problem, the target variable is a class identified amount a predefined list of classes relating to the problem domain. In embodiments, where the problem domain relates to a regression problem, the target variable is a numeric value.

References to classical system such as system 110 of FIG. 1 in this disclosure include computers that perform computation using binary encoding of information (classical information). The quantum computing system 130 performs computations on quantum information. The quantum computing system receives input in the form of classical information and generates output in the form of classical information. However, computations by the quantum computer system are perform by transforming the classical information into quantum information represented using qubits provided in the quantum computer system. The qubits form part of a quantum circuit 140 that is used to implement a quantum neural network (QNN) 142. The quantum circuit may also be referred to as a variational circuit or an Ansatz. Like a convention neural network implemented by a classical computer, the QNN comprises a series of layers to process information, wherein each layer comprises a set of computations in the quantum realm. The data encoding layer 144 transforms classical information obtained from the classical system into quantum information. Practically, this step involves transforming classical information such as a scaler or numeric value into a quantum state vector encoded in a qubit according to an encoding scheme. A suitable encoding scheme may be implemented by the embodiments depending on the nature of the problem domain dataset. Suitable encoding schemes include angle encoding where classical information is represented as angle configurations of one or more qubits. In some embodiments, each feature of the problem domain dataset in mapped to one qubit. In some embodiments, each qubit may be used to store information relating to more than one features. This may be achieved by an encoding scheme wherein rotation of a qubit with respect to two of the axes is used to encode a two feature values. For example, rotation of a qubit Q₁ with respect to x-axis may be used to encode feature F₁, while rotation of the qubit Q₁ with respect to y-axis may be used encode feature F₂.

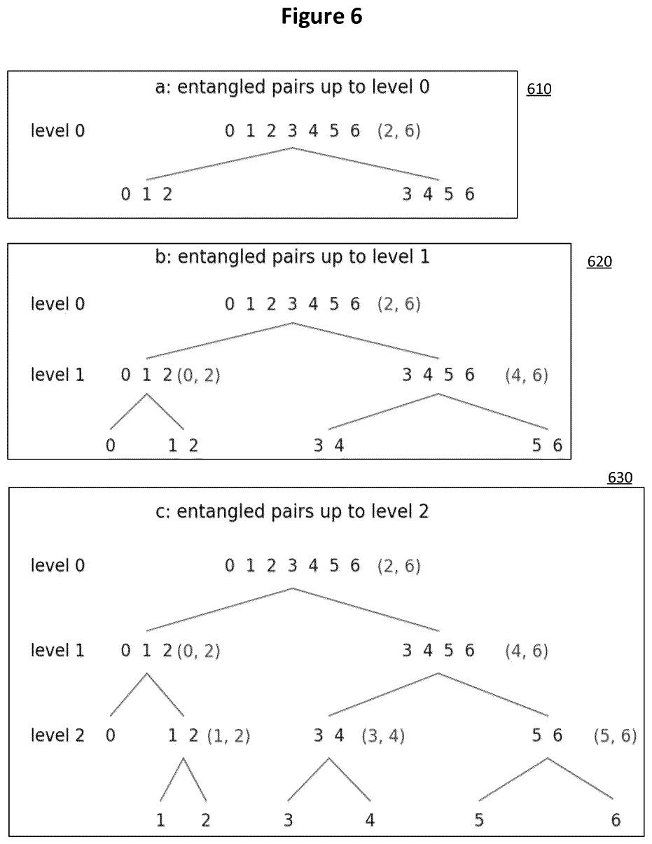

The data processing layer 146 comprises operations that are performed on the quantum data encoded in the quantum circuit. The operations are defined or parameterized by configuration values defined in the associated QNN configuration. The operations comprise unitary operations such as pauli operations, Hadamard operations, phase operation, rotation operations etc. Each operation may be parameterized by one or more parameters that may be varied to control the operations performed on the quantum information. Each QNN comprises one or more than one data processing layers to perform a series of operations on the encoded quantum states. The number of such layers is a function of the complexity of the problem domain. Simple problems may be addressed by fewer layers while complex problems may require a larger number of layers. In addition to operations, the data processing layers may also include one or more entanglement relationships between the qubits to model the complexity of the problem domain. The entanglements may be defined according to a predefined scheme, an example of which has been described with reference to FIG. 6. Finally, the output layer 148 comprises one or more measurement elements to readout the results of the operations performed by the QNN into the classical realm. The output layer and readout steps may be accompanied by a post-processing scheme for translating the output probability distribution from a series of measurements into a predicted target variable. Examples of such post-processing schemes include parity post-processing or measurement of a single qubit for binary classification problems. For regression problems, the post-processing scheme may include measurement of expectation values of outputs of multiple qubits of the QNN and transformation of the multiple expectation values into a regression value. The various parameters and structure of the QNN 142 can be summarized as a QNN configuration 134. In essence, with the QNN configuration at hand, a quantum circuit can be arranged or configured to generate the QNN of interest. The quantum computing system 130 also comprises a quantum circuit controller 132 to manipulate the quantum circuit 140 based on the QNN configuration. The quantum computing system receives QNN configuration values from the classical system and arranges the quantum circuit to implement the QNN as defined in the received QNN configuration. QNN configuration may include parameters defining the various characteristics of a QNN including number of layers, number of qubits, mapping of features to qubits, parameters defining operations performed in each layer of the QNN, number of quantum circuit runs etc. The parameters defining operations performed in each layer may include specific quantum operations/gates applied to the quantum information in a particular layer, values defining rotation operations performed on quantum information etc.

The classical system 110 comprises one or more processor 112 to perform operations on classical information and execute the genetic algorithms for determining a target QNN configuration for a problem domain dataset. The classical system also comprises memory 114 that comprises executable code to perform the steps of the methods of the embodiments. The modules implemented by the classical system include a genetic search module 116 and a quantum computing simulation module 118. The genetic search module comprises executable code and configurable parameters to execute the genetic search. The QC simulation module allows the simulation of a quantum circuit and its associated quantum operations to allow supervision of the genetic search performed by the genetic search module. Both the classical system and the QC system comprises communication interfaces 119 and 136. The communication interfaces include hardware and software elements to allow communication of information by the respective systems. Appropriate network connections are provided between the database 120, classical system 110 and the QC system 130 to allow the three components to interact with each other and share data/information.

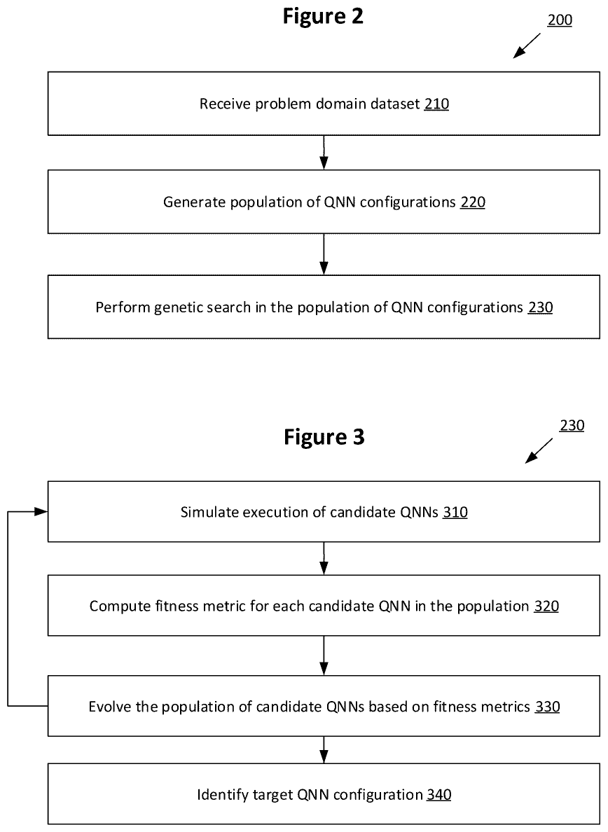

FIG. 2 illustrates a method 200 of determining a target QNN configuration executable by at least a part of the system of FIG. 1. The method 200 is performed to generate a target QNN configuration which defines a quantum circuit that is best suited for generating predictions in relation to a problem domain. The approach of the method 200 is agnostic to the nature of the machine learning problem at hand. Method 200 is applicable to both classification problems and regression problems. Quantum circuits for regression and classification implement different structures in their respective output layers to generate a scaler value or a classification label. However, the overall approach of method 200 is applicable to both classes of problems.

Genetic algorithms mimic the evolution processes in nature to find optimal solutions to problems. In nature, organisms evolve to adapt to pressures from the environment by the process of natural selection. Genetic algorithms implement natural selection by numerically evaluating the fitness of each solution in a population of candidate solutions. At step 210, the classical system 110 receives or access a problem domain dataset. The problem domain dataset may be received from the database 120 or any other data store accessible by the classical system 110. The received dataset comprises a plurality of feature data and target variable data.

At step 220, the classical system generates a population of QNN configurations (candidate QNN configurations). The various parameters of the QNN configurations are randomly generated. However, the generation of the random parameter values is constrained within ranges to produce practically meaningful QNN configurations. For example, the parameter values for rotation operations are randomly generated within the range of 0 to 360 degrees. In addition, the QNN configuration also includes a random mapping of features to qubits. For example, for a problem domain dataset with features F₁, F₂ and F₃, random mappings of the features to a 3 qubit QNN (Q₁, Q₂, Q₃) could include: [F₁->Q₁, F₂->Q₂, F₃->Q₃], [F₁->Q₃, F₂->Q₂, F₃->Q₁] etc. The random mapping of features to qubits allows the exploration of a large number of QNN structures in a population of candidate QNN configurations. In some embodiments, 2 features may be mapped to a single qubit by encoding the feature values using rotation of the qubit with respect to the x-axis and y-axis for example. Depending on the range of values of each feature in the problem domain dataset, a suitable encoding mechanism is adopted to map the scaler values to the quantum states.

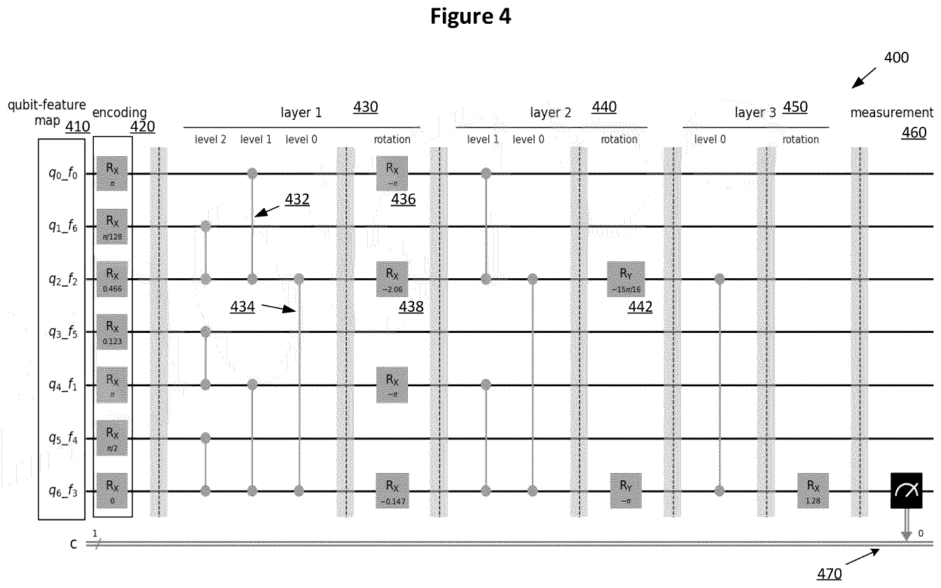

At step 230 a genetic search for a target configuration is performed. The flowchart of FIG. 3 provides detailed steps of the genetic search. At step 310, the population of QNN configurations initialized at step 220 is used to create QNNs and the created QNNs are executed. In some embodiments, the QNNs may be simulated in a classical computer using the QC simulation module 118. Execution of the QNN involves processing the problem domain dataset received at step 210 to generate predictions.

At step 320, the output of execution of QNNs obtained at step 310 is used to evaluate a fitness metric for each QNN configuration. The fitness metric indicates the accuracy of results generated by the QNN corresponding to the QNN configuration. Different fitness or accuracy assessment metrics may be utilized depending on the problem domain. Examples include false positive rate, false negative rate, true negative rates, negative prediction values, false discovery rate, true positive rate, positive prediction value etc. or a combination of multiple metrics.

For example, for a problem relating to binary classification (classification between classes A and B), the QNN may be configured to generate a probability (y_{pred}) of a record in the problem domain dataset falling into to class A. The corresponding target variable for each record may be a known probability (y_{actual}) of a record belonging to class A. For each sampled point in the problem domain dataset, the following computation is performed:

diff=abs(y_{pred}−y_{actual})

Return an output cost based on:
diff<0.2:0
0.2≤diff<0.45:1
0.45≤diff<0.55:2
0.55≤diff<0.8:3
0.8≤diff:4
   costₜₒₜₐₗ is computed as the sum of costs for all sampled points, and a fitness metric may be computed as the reciprocal of the costₜₒₜₐₗ. Cost or fitness metrics may be interchangeably used to drive the generic search with the same fundamental objective of identifying a target QNN configuration that provides the most accurate results. In some embodiments, some optimization steps may be performed as part of the computation of fitness metric. For example, for a binary classification problem, if the class predicted by a QNN is consistently incorrect to a high degree, the QNN configuration may be modified to reverse the labels as the genetic search is continued. Using above example of cost computation,

if 4*sample size−costₜₒₜₐₗ<costₜₒₜₐₗ/2

then update the QNN configuration to reverse labels and update the cost function to

New costₜₒₜₐₗ=4*sample size−costₜₒₜₐₗ

At step 330 evolution operations are performed based on the computed fitness metrics. The evolution operations include selection of a subset of the QNN configurations based on the computed fitness metrics. For example, QNN configurations above a predefined fitness metric threshold may be select for the next round of evolution. Alternatively, the QNN configurations may be ranked and a top 10% or 20% QNN configurations may be selected for the next round of evolution. The selection mechanism may be guided by the computational resource constraints, complexity of the problem domain and size of the initial population. A more complex problem domain may require a larger size of the initial population of QNN configuration and a gradual selection mechanism allowing a longer search for the target QNN configuration. A less complex problem domain may be addressed by a smaller initial population of QNN configurations.

Evolution operations at step 330 may also include a random mutation of a subset of QNN configurations to broaden the search in the solution space. Mutation may be controlled by hyperparameters a and B, wherein a is the mutation rate and B is the decay rate. Over each iteration of the step 330, the mutation rate is reduced by the decay rate value. In some embodiments mutation may be performed by altering one or more rotation parameters of the quantum operations defined in the QNN configurations. As an example, a random number (between 0 and 1) may be generated for each rotation operation in a QNN configuration. If the random number is less than a, then the parameter for the rotation operation is replaced by a new randomly generate parameter to mutate the QNN configuration. By mutation of the QNN configuration, the genetic search process explores the solution space and evolves the population towards a target QNN configuration that provides more accurate results. With the mutation and selection operation performed at step 330, a subsequent population of QNN configurations is generated for the next round of evolution. Step 330 is followed by step 310 when evolution termination conditions are not met. The subsequent population of QNN configurations are used to simulate QNNs, followed by computation of fitness metrics at step 320 and further evolution at step 330.

Step 330 also include evaluation of an evolution termination condition. The evolution termination condition is used to assess whether the population of QNNs is continuing to progress towards a more optimal target QNN configuration. The evolution termination condition may include assessing whether fitness of the top cohort (for example a top 10 or top 5 etc.) of QNN configurations is improving over the iterations of evolution. The evolution termination condition may also include assessing whether any new QNN configurations are being added to a top cohort of QNN configurations. On the evolution meeting an evolution termination condition, the process proceeds to step 340 where the QNN configuration with the highest fitness is identified as the target QNN configuration.

After having identified the target QNN configuration, a QNN generated based on the target QNN configuration may be deployed to process live data previously unseen by the QNN and generate predictions. The live data may be generated in a real-world production setting whereby inferences or predictions generated by the QNN may allow real-world decision making or actions based on the inferences. Steps 310, 320 and 330 when repeatedly performed constitute iterative evolution of the population of candidate QNNs initialized at step 220.

The methods of some embodiments further include the step of deploying a QNN on a quantum computing system based on the identified target QNN configuration. The deployed QNN is configured to process live data and generate inferences that could drive real world actions or decision making.

To improve the performance and accuracy of the genetic algorithm and the QNNs, some embodiments incorporate certain optimization techniques. One such technique is random sampling of records to simulate execution of QNNs at step 310 of FIG. 3. Instead of simulating execution of QNNs for the entire problem domain dataset, the QNNs may be simulated to process a random sampling of representative data to speed up the genetic search of step 230.

Another optimization technique involves use of guiding features. In some embodiments, guiding features are randomly selected features that are encoded into a qubit to improve the accuracy of results provided by a QNN. In addition, the use of guiding features improves the time required for convergence by providing additional information input to the QNN. Guiding features may be encoded using an additional qubit or they may be encoded into a qubit in combination with another feature. When encoded in combination with another feature, the guiding feature may be encoded using an angle encoding with respect to an axis that is different from the other feature. The QNN configuration for embodiments incorporating this optimization technique included configuration of which features are being used as guiding features and which qubit is used to encode the randomly selected guiding feature. The use of randomly selected guiding features and the variability in encoding of such features with QNNs further broadens the search space for the genetic search allowing the possibility of identification of a more optimal target QNN configuration. In some embodiments, guiding features may be features defined based on conventional machine learning feature engineering operations and may be based on a combination of one or more features in the problem domain dataset.

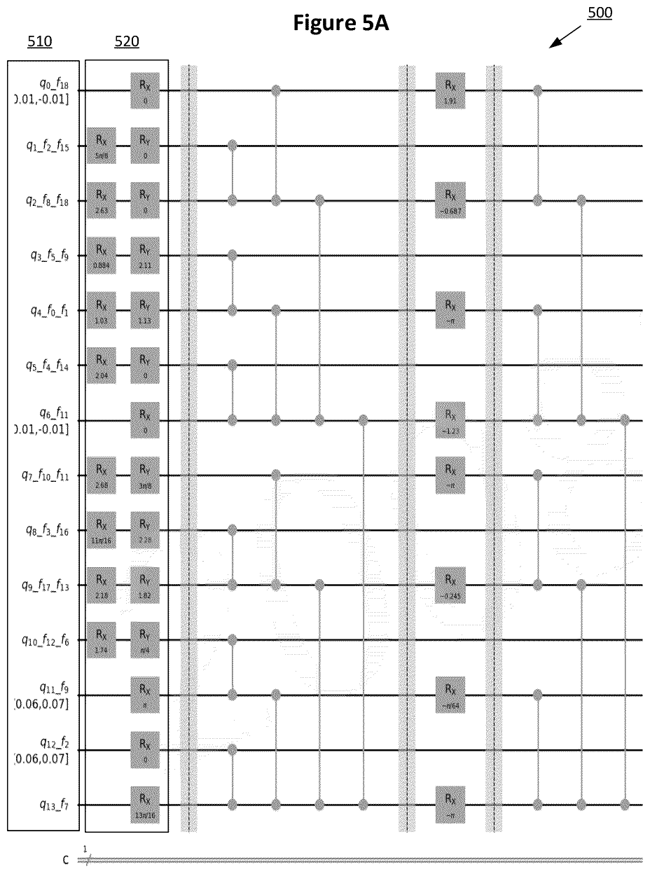

FIG. 4 illustrates a quantum circuit implementing a QNN 400 generated by implementing an example of a target QNN configuration identified by the methods of the disclosure. The QNN 400 is intended to perform binary prediction based on the input features. A qubit-feature map 410 illustrates the mapping of various features to the qubits of the QNN. In QNN 400 the following mapping is applied to the features [[q₀, f₀], [q₁, f₆], [q₂, f₂], [q₃, f₅], [q₄, f₁], [q₅, f₄], [q₆, f₃]]. This is an example of a mapping of 6 features to 6 qubits for a particular problem domain. In the population of QNN configurations generated during the execution of the methods of the disclosure, other mappings of features to qubits may have been initialized to allow a search in the solution space.

Followed by the qubit-feature map is an encoding layer that encodes information of samples in the problem domain to the respective qubits. For each iteration of execution/simulation of QNN 400, the parameters of the encoding layer 420 are varied based on the respective feature values to obtain a measurement/prediction/inference in the measurement layer 460. Between the measurement layer and the encoding layer are provided data processing layers 430, 440 and 450. Various quantum operations are performed on the quantum information in the data processing layers. Examples of operations include a rotation operation represented by blocks 436, 438 and 442. The quantum operations are parameterised by configuration parameters that form a part of the QNN configuration corresponding to a quantum circuit. As a QNN configuration is evolved at step 330 of FIG. 3, mutation operations may be performed on the QNN configuration. The mutation operations may comprise introduction of random changes to the quantum operations performed in the data processing layers of a QNN as parameterised by the corresponding QNN configuration.

In each of the processing layers, there exist entanglement relationships between the qubits and quantum operations on the quantum states of the qubits. For example, in QNN 400, entanglement relationships 432 (q₀-q₂ in level 1 of layer 1), 434 (q₂-q₆ in level 0 of layer 1) are identified. QNN 400 comprises other entanglement relationships in its various layers as illustrated by the vertical lines connecting the horizontal lines corresponding to the qubits. The entanglement relationships are defined according to a structured entanglement relationship definition scheme. FIG. 6 illustrates one such entanglement relationship definition scheme incorporated by some embodiments. The entanglement relationships in each QNN provide complex quantum operations between the qubits allowing to build up complexity in the QNN. By building up complexity in the QNN, the entanglement relationships allow the modelling of a complex real world problem domain in the QNNs to allow the search for a more optimal target QNN. In some embodiments, the structure of the entanglement relationships across the entire population of QNNs initialized at step 220 of FIG. 2 is kept consistent across the population. In such embodiments, the genetic search focuses on the mapping of features to qubits and the parameters of the quantum operations in the various layers of the QNN.

Also provided in QNN 400 is a classical bit 470 for generating a readout or measurement of the quantum computations. As quantum circuits perform probabilistic computation, for each iteration of execution of the quantum circuit for a sample of data is repeated multiple times (for example, 100 or 1000 times) to obtain a distribution of the classical output. Based on the distribution of the classical output, an inference may be obtained in related to the data. For example, for a binary classification result, the distribution of the classical readout bit across (0,1) may be mapped to the two classes being considered. Similarly, for multi-class classification problems, multiple readout classical bits may be provided in the QNN to allow generation of a probability distribution over multiple classes. A similar readout/measurement mechanism may be provided for regression or scaler value estimation problems.

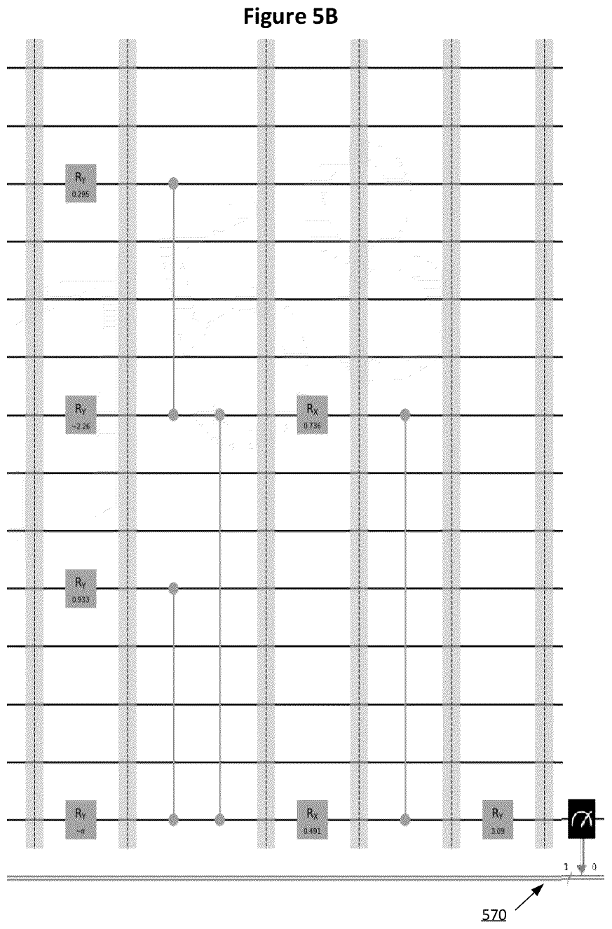

FIGS. 5A and 5B illustrate another quantum circuit generated by implementing a QNN 500. The QNN 500's structure extends over the FIGS. 5A and 5B. FIGS. 5A and 5B are intended to be viewed in conjunction. QNN 500 also relates to a binary classification problem. QNN 500 also comprises entanglement relationships, operations, and layers like the QNN 400. However, unlike QNN 400, in QNN 500's qubit-feature map 510, multiple features have been mapped to a single qubit. For example, q1 has been mapped to f2 and f15. Q2 has been mapped to f8 and f16. The mapping of multiple features to a single qubit allows the simplification of the QNN without compromising on the ability of the QNN to consume information from a complex problem domain with a large number of features. With a more simplified QNN structure, the genetic algorithm is also sped up because the need for optimization of fewer parameters. Also illustrated in FIG. 5A is an encoding layer 520 which encodes feature data into the qubits by rotation operations. Note that the qubits to which two features are mapped require two rotation operations to encode the data of the two features. Also provided in QNN is the classical bit 570 (illustrated in FIG. 5B) to readout the measurement of the computations of the QNN.

FIG. 6 illustrates a schematic diagram of a scheme for defining multi-layered hierarchical entanglement relationships in quantum circuits in some embodiments. The approach of FIG. 6 is one example of defining entanglement relationships. Embodiments may incorporate other approaches for building entanglement within QNNs. Each population of QNN configuration may include QNN with one or more types of entanglement schemes. For example, for problems domains with a high complexity, the initial QNN configuration population may be initialized with a greater variety of entanglement relationships to allow for a broader genetic search. For problems domains with a lower complexity, a single entanglement schematic can be used to generate the entire population of QNN configurations to simplify the search.

The approach of the entanglement relationships illustrated in FIG. 6 is to split the overall number of qubits in half (or approximately half for odd number of qubits) to establish a multi-level tree like hierarchy. Each level of the multi-level tree like hierarchy comprises multiple qubit groups. The various qubit groups are iteratively split into smaller qubit groups down the hierarchy. The split operations to define the entanglement ratio is governed by a parameter referred to as a tree split ratio. In FIG. 6, the tree split ratio is approximately 0.5. The three terminates at the stage where each leaf node of the tree corresponds to a desired number of qubits. Each level of the tree structure relates to a level or depth of entanglements build up in the corresponding QNN. The reference numbers in the tree structures in FIG. 6 are index numbers of qubits in the QNN.

Schematic 610 illustrates an entanglement scheme with a depth of level 0. Schematic 610 includes an entanglement relationship between q2 and q6. As the total number of qubits is 7, the qubits are split into two groups (0, 1, 2) and (3, 4, 5, 6). At level 0, entanglement relationships are provided between q2 and q6, the final members of the two groups obtained after the split.

Schematic 620 illustrates an entanglement scheme with an additional depth of level 1 on top of the scheme of schematic 610. At level 1, the two groups of qubits are further split into groups [(0), (1, 2)], [(3, 4) and (5, 6)]. Entanglement relationships are built up between the final members of the split groups: [0, 2] and [4, 6] in addition to the previously built entanglement relationship [2, 6].

Schematic 630 illustrates an entanglement scheme with an additional depth of level 2 on top of the scheme of schematic 620. At level 2, the groups of qubits are further splint into the respective leaf nodes with one qubit each. The additional entanglement relationships added are [1,2], [3,4] and [5,6]. Layer 1 of QNN 400 embodies the entanglement scheme illustrated in schematic 630. Layer 2 of QNN 400 embodies the entanglement scheme illustrated in schematic 620. Layer 3 of QNN 400 embodies the entanglement scheme illustrated in schematic 610. The various depths of entanglement relationships illustrated in FIG. 6 can be layered in the QNNs, with the more complex/dense relationships (schematic 630) preceding the space relationships (schematic 610). The entanglement structures of QNN 500 follow a similar pattern, although with a larger number of qubits.

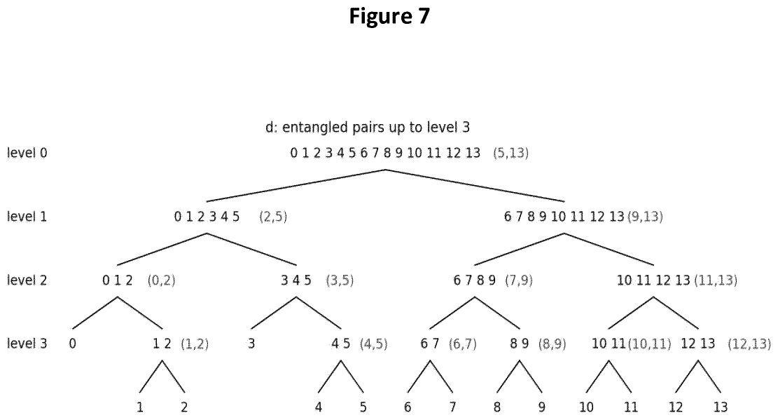

FIG. 7 illustrates another example of a scheme for defining multi-layered hierarchical entanglement relationships in quantum circuits. The tree split ratio for the entanglement scheme of FIG. 7 is approximately 0.43. Following this tree split ratio, at level 1 of FIG. 7, the qubits are split into two groups of 6 (qubits 0 to 5) and 8 (qubits 6 to 13) (6/14≈0.43). At level two, the qubits groups are split into further qubit groups to provide a ratio closest to the tree split ratio 0.43. In the entanglement scheme of FIG. 7, the following entanglement relationship are defined:
Level 0: split tree into qubit groups (qubits 0-5, and qubits 6-13), entangle qubits 5 and 13
Level 1: split tree into qubit groups (qubits 0-2, qubits 3-5, qubits 6-9, and qubits 10-13), entangle qubits (2, 3) and (9, 13)
Level 2: split tree into qubit groups (qubit 0, qubit 1-2, qubit 3, qubits 4-5, qubits 6-7, qubits 8-9, qubits 10-11, and qubits 12-13), entangle qubits (0, 2), (3, 5), (7, 9) and (11, 13)
Level 3: split tree into final leaf nodes corresponding to qubits 1 to 13 and entangle qubits (1, 2), (4, 5), (6, 7), (8, 9), (10, 11), and (12-13)

Because of the smaller number of qubits in FIG. 7, the split ratio at the subsequent levels (levels 2 and 3) reverts to the ratio of 0.5. However, in quantum circuits with larger number of qubits or for tree split ratios substantially different from 0.5 (for example a ratio of 0.2), the entanglement schemes may introduce greater asymmetry in the structure of QNNs. The generated population of QNN configurations at 220 of FIG. 2 may include QNN configurations initialized using a range of tree split ratios. By varying the tree split ratio in a population of candidate QNN configurations, some embodiments advantageously allow a wider exploration of the solution space enabling discovery of more optimal QNN configurations relevant to a problem domain. The tree split ratio may vary within the range of 0.2 to 0.8, for example.

Some embodiments of the disclosure relate to a quantum computing system, with a quantum circuit implementing a target QNN configuration identified by the methods for determining a target QNN configuration of this disclosure. The quantum computing systems of such embodiments operate in concert with classical systems and databases to receive data and transmit inferences or results generated by its computations.

1. A method for determining a target Quantum Neural Network (QNN) configuration for binary classification, the method comprising:
receiving a binary classification dataset, the dataset comprising a plurality of feature data and target classification data;
generating a population of candidate QNN configurations based on the plurality of features, each candidate QNN configuration defining a QNN comprising a random mapping of each of the plurality of features to at least one qubit of the QNN and entanglement relationships between the qubits;
performing a genetic search in the population of QNN configurations for a target QNN configuration by:
simulated execution of candidate QNNs initialized using the each QNN configuration in the population of QNN configurations;
computing a fitness metric for each of the candidate QNNs based on outputs of simulated execution of the candidate QNNs and the target classification data; and
iteratively evolving the population of QNN configurations based on the fitness metrics to identify a target QNN configuration with the highest fitness metric.

2. The method of claim 1, wherein iterative evolution of the population of QNN configurations comprises:
selection of a subset of the QNN configurations based on the computed fitness metrics;
generation of a subsequent population of QNN configurations by random mutation operations on the subset of the QNN configurations.

3. The method of claim 1, wherein each QNN configuration comprises at least one configuration value defining operations performed on qubits in each layer of the QNN.

4. The method of claim 1, wherein the entanglement relationships between the qubits of the QNNs defined by the QNN configurations comprise multi-layered hierarchical entanglement relationships.

5. The method of claim 4, wherein the multi-layered hierarchical entanglement relationships comprise two qubit groups at each layer, wherein number of qubits in the two qubit groups at each layer are determined based on a tree split ratio.

6. The method of claim 1, wherein the method further comprises:
generating at least one guiding feature based on one or more of the plurality of features; and
each candidate QNN configuration comprising a mapping of each guiding feature to at least one qubit as defined in the QNN configuration.

7. The method of claim 1, wherein the method further comprises random sampling of records in the domain dataset; and
simulated execution of candidate QNNs using the randomly sampled records.

8. The method of claim 1, wherein the method further comprises defining a QNN based on the identified target QNN configuration; and
deploying the QNN based on the identified target QNN configuration to process live data and generate binary classification inferences.

9. The method of claim 1, wherein the number of qubits in each candidate QNN configuration is less than the total number of features in the dataset; and at least a subset of qubits in each QNN configuration encode more than one feature data.

10. A method for determining a target Quantum Neural Network (QNN) configuration for a problem domain, the method comprising:
receiving a problem domain dataset, the dataset comprising a plurality of feature data and target variable data;
generating a population of candidate QNN configurations based on the plurality of features, each candidate QNN configuration defining a QNN comprising a random mapping of each of the plurality of features to at least one qubit of the QNN and entanglement relationships between the qubits;
performing a genetic search in the population of QNN configurations for a target QNN configuration by:
simulated execution of candidate QNNs initialized using the each QNN configuration in the population of QNN configurations;
computing a fitness metric for each of the candidate QNNs based on outputs of simulated execution of the candidate QNNs and the target variable data; and
iteratively evolving the population of QNN configurations based on the fitness metrics to identify a target QNN configuration with the highest fitness metric.

11. The method of claim 10, wherein iterative evolution of the population of QNN configurations comprises:
selection of a subset of the QNN configurations based on the computed fitness metrics;
generation of a subsequent population of QNN configurations by random mutation operations on the subset of the QNN configurations.

12. The method of claim 10, wherein each QNN configuration comprises at least one configuration value defining operations performed on qubits in each layer of the QNN.

13. The method of claim 10, wherein the entanglement relationships between the qubits of the QNNs defined by the QNN configurations comprise multi-layered hierarchical entanglement relationships.

14. The method of claim 13, wherein the multi-layered hierarchical entanglement relationships comprise two qubit groups at each layer, wherein the number of qubits in the two qubit groups at each layer are determined based on a tree split ratio.

15. The method of claim 11, wherein the method further comprises:
generating at least one guiding feature based on one or more of the plurality of features; and
each candidate QNN configuration comprising a mapping of each guiding feature to at least one qubit as defined in the QNN configuration.

16. The method of claim 10, wherein the method further comprises random sampling of records in the domain dataset; and
simulated execution of candidate QNNs used the randomly sampled records.

17. The method of claim 10, wherein the method further comprises defining a QNN based on the identified target QNN configuration; and
deploying the QNN based on the identified target QNN configuration to process live data and generate inferences.

18. The method of claim 10, wherein the number of qubits in each candidate QNN configuration is less than the total number of features in the dataset; and at least a subset of qubits in each QNN configuration encode more than one feature data.

19. A quantum computing system, the system comprising:
a quantum circuit generated according to a target QNN configuration, wherein the target QNN configuration is determined by execution of the method of claim 1.

20. A quantum computing system, the system comprising:
a quantum circuit generated according to a target QNN configuration, wherein the target QNN configuration is determined by execution of the method of claim 10.
